(19) United States
(12) Patent Application Publication
(10) Pub. No.: US 2017/0063427 A1
(43) Pub. Date: Mar. 2, 2017

(54) ANALOG INTERFERENCE CANCELATION FOR SHARED ANTENNAS

(71) Applicant: QUALCOMM Incorporated, San Diego, CA (US)

(72) Inventors: Won-ick LEE, San Diego, CA (US); Insoo HWANG, San Diego, CA (US); Kaushik CHAKRABORTY, San Diego, CA (US); Ozgur DURAL, San Diego, CA (US); Samir Salib Soliman, Poway, CA (US); Mark Anthony MAGGENTI, Del Mar, CA (US)

(21) Appl. No.: 14/838,226

(22) Filed: Aug. 27, 2015

(51) Int. Cl. H04B 1/48; H04B 1/56

(52) U.S. Cl. CPC H04B 1/48; H04B 1/56; H04B 2001/485

(57) ABSTRACT

Various aspects described herein relate to providing analog interference cancelation in a shared antenna. A plurality of signals can be obtained at a plurality of reference points in a transmitter chain of a shared antenna. At least one reference point of the plurality of reference points from which to generate a cancelation signal and/or at least one injection point for injecting the cancelation signal can be selected based at least in part on expected analog interference cancelation metrics related to each of the plurality of reference points and/or the at least one injection point. The cancelation signal can be generated based at least in part on the at least one reference point and/or injection point. The cancelation signal can be injected in the injection point at a receiver chain of the shared antenna to cancel interference from signals generated at the transmitter chain of the shared antenna.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). Generally, a wireless multiple-access communication system can simultaneously support communication for multiple wireless terminals (e.g., user equipment (UE)), each of which can communicate with one or more base stations over downlink or uplink resources.

In some LTE (or other wireless communication technology) configurations, uplink carrier aggregation is provided to allow communications over multiple carriers between a UE and a base station. The UE can utilize a shared antenna with multiple radio frequency (RF) chains in an RF front end to transmit over multiple uplink carriers (and receive over multiple downlink carriers). Transmission from one or more transmitter chains in an RF front end that utilizes a shared antenna can cause self-interference to a receiver chain receiving signals over the shared antenna. The self-interference may be in the form of out-of-band (OOB) emissions or inter-modulation (IMD) of a signal from the transmitter chain (e.g., an aggressor RF path) towards a receiver chain (e.g., a victim RF path) in the shared antenna configuration. The OOB emissions or IMD can desense a receiver sensitivity of a victim receiver. Digital interference cancelation has been provided, but cannot prevent saturation of low-noise amplifiers in the RF front end.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an example, a method for providing analog interference cancelation in a shared antenna is provided. The method includes obtaining a plurality of signals at a plurality of reference points in a transmitter chain of a shared antenna, selecting at least one reference point of the plurality of reference points from which to generate a cancelation signal and/or at least one injection point for injecting the cancelation signal based at least in part on expected analog interference cancelation metrics related to each of the plurality of reference points and/or the at least one injection point, generating the cancelation signal based at least in part on the at least one reference point and/or the at least one injection point, and injecting the cancelation signal in the at least one injection point at a receiver chain of the shared antenna to cancel interference from signals generated at the transmitter chain of the shared antenna.

In another example, an apparatus for providing analog interference cancelation in a shared antenna is provided. The apparatus includes an antenna shared between a transmitter chain and a receiver chain, at least one processor communicatively coupled with the transmitter chain and the receiver chain via a bus, and a memory communicatively coupled with the transmitter chain, the receiver chain, and the at least one processor via the bus. The at least one processor and the memory are operable to obtain a plurality of signals at a plurality of reference points in the transmitter chain of a shared antenna, select at least one reference point of the plurality of reference points from which to generate a cancelation signal and/or at least one injection point for injecting the cancelation signal based at least in part on expected analog interference cancelation metrics related to each of the plurality of reference points and/or the at least one injection point, generate the cancelation signal based at least in part on the at least one reference point and/or the at least one injection point, and inject the cancelation signal in the at least one injection point at the receiver chain of the shared antenna to cancel interference from signals generated at the transmitter chain of the shared antenna.

In a further example, an apparatus for providing analog interference cancelation in a shared antenna is provided. The apparatus includes means for obtaining a plurality of signals at a plurality of reference points in a transmitter chain of a shared antenna, means for selecting at least one reference point of the plurality of reference points from which to generate a cancelation signal and/or at least one injection point for injecting the cancelation signal based at least in part on expected analog interference cancelation metrics related to each of the plurality of reference points and/or the at least one injection point, means for generating the cancelation signal based at least in part on the at least one reference point and/or the at least one injection point, and means for injecting the cancelation signal in the at least one injection point at a receiver chain of the shared antenna to cancel interference from signals generated at the transmitter chain of the shared antenna.

Moreover, in an example, a computer-readable medium storing code executable by a computer for providing analog interference cancelation in a shared antenna is provided. The code includes code for obtaining a plurality of signals at a plurality of reference points in a transmitter chain of a shared antenna, code for selecting at least one reference point of the plurality of reference points from which to generate a cancelation signal and/or at least one injection point for injecting the cancelation signal based at least in part on expected analog interference cancelation metrics related to each of the plurality of reference points and/or the at least one injection point, code for generating the cancelation signal based at least in part on the at least one reference point and/or the at least one injection point, and code for injecting the cancelation signal in the at least one injection point at a receiver chain of the shared antenna to cancel interference from signals generated at the transmitter chain of the shared antenna.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The accompanying drawings are presented to aid in the description of various aspects of the disclosure and are provided solely for illustration of the aspects and not limitation thereof. The drawings include like reference numbers for like elements, and may represent optional components or actions using dashed lines.

FIG. 1 is a block diagram illustrating an example wireless communications system including a device having an antenna shared between a transmitter chain and a receiver chain and being configured for providing analog interference cancelation, according to aspects described herein.

FIG. 2 is a method flow diagram of an example method for generating and injecting a cancelation signal for providing analog interference cancelation in a device having a shared antenna, in accordance with aspects described herein.

FIG. 3 is a method flow diagram of another example method for generating and injecting a cancelation signal for providing analog interference cancelation in a device having a shared antenna, in accordance with aspects described herein.

FIGS. 4-7 are block diagrams conceptually illustrating example shared antenna and RF front end configurations for providing analog interference cancelation in a device having a shared antenna, in accordance with aspects described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. Also, the term “component” as used herein may be one of the parts that make up a system, may be hardware, firmware, and/or software, and may be divided into other functions.

Described herein are various aspects related to performing analog interference cancelation in a shared antenna configuration. For example, cancelation signals can be generated based on multiple reference points in a radio frequency (RF) front end of a device communicating in a wireless network, where the device may include a UE, base station, relay node, etc., or substantially any node capable over wireless communications using a shared antenna. One or more of the cancelation signals can be selected based on one or more metrics thereof, and the selected cancelation signal(s) can be injected into one or more cancelation points in the RF front end to perform analog interference cancelation for the shared antenna. For example, selection of the cancelation signal(s) can be based on at least one of determining matching components of the cancelation signal(s), determining an expected analog interference cancelation gain of the cancelation signal(s), expected analog interference cancelation cost of the cancelation signal(s), etc.

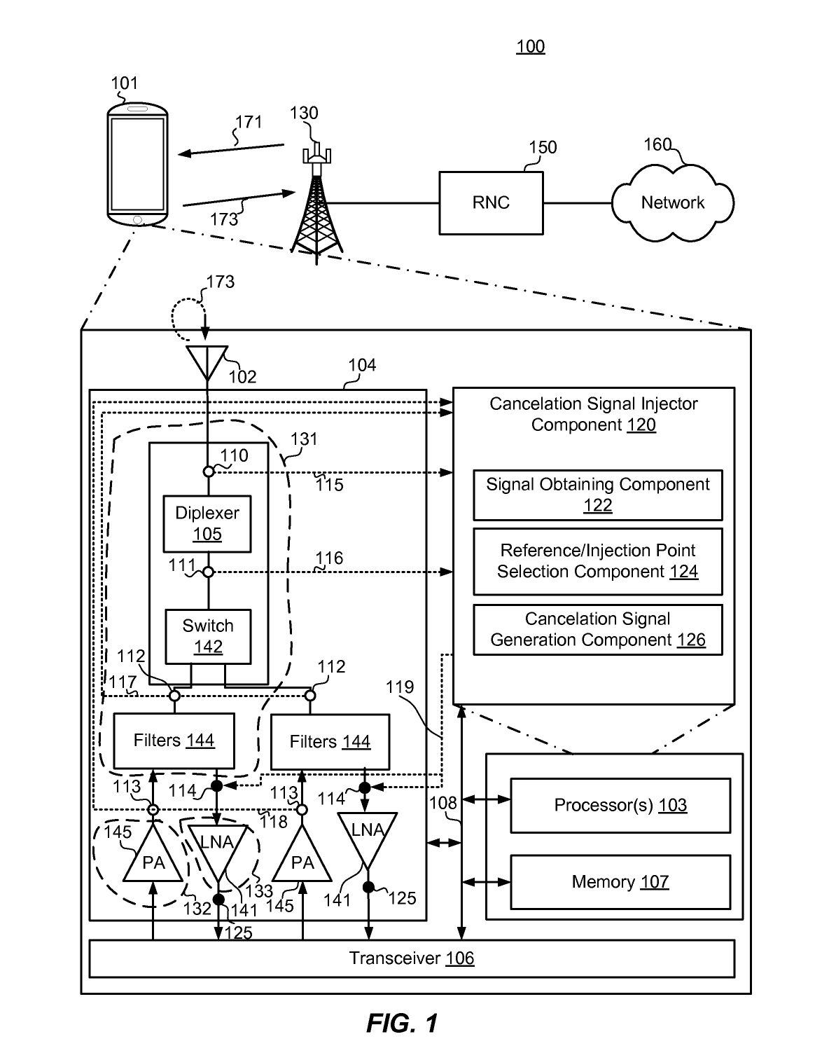

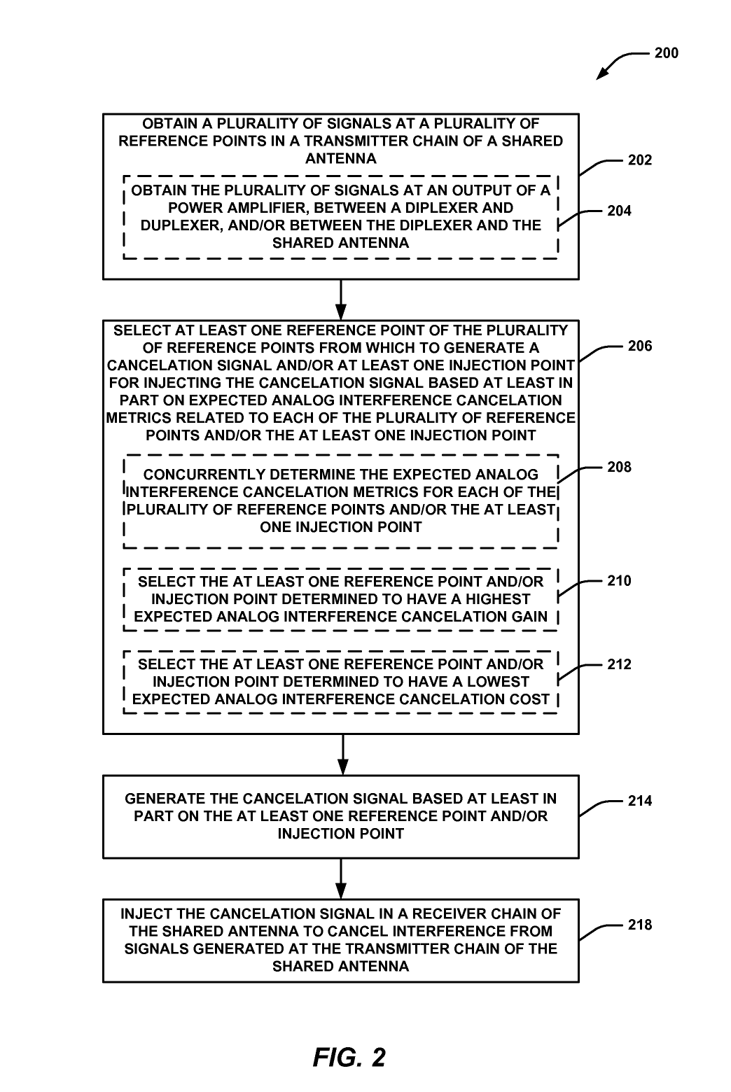

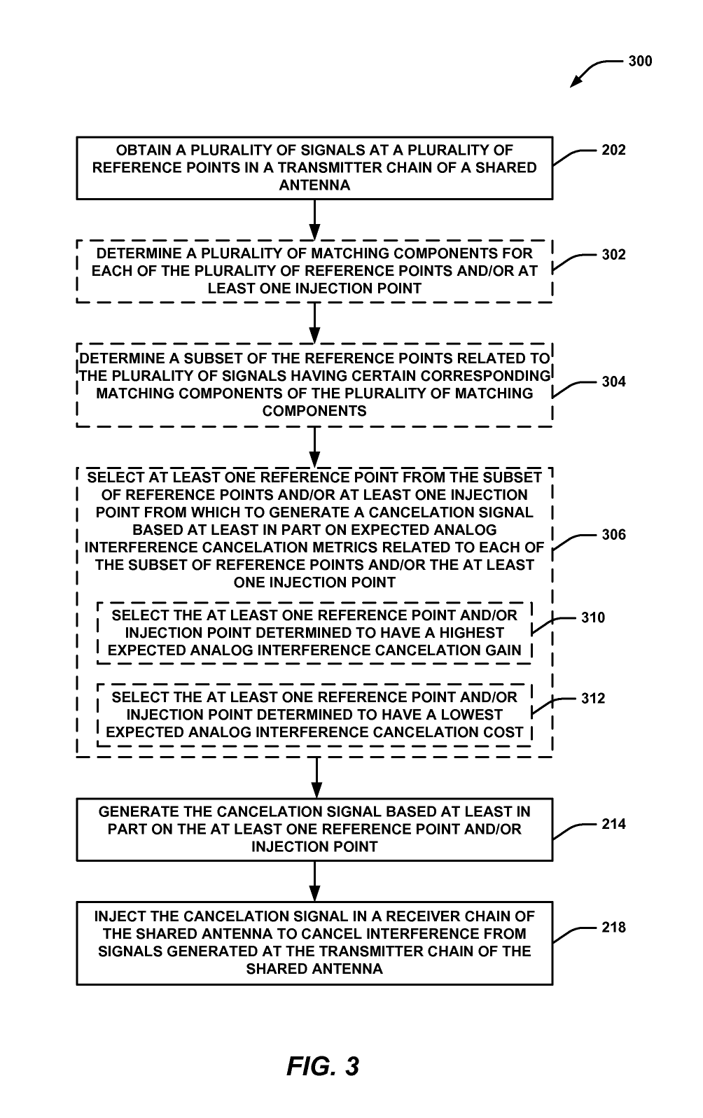

Referring to FIGS. 1-3, aspects are depicted with reference to one or more components and one or more methods that may perform the actions or operations described herein. Although the operations described below in FIGS. 2 and 3 are presented in a particular order and/or as being performed by an example function, it should be understood that the ordering of the actions and the functions performing the actions may be varied, depending on the implementation. Moreover, it should be understood that the following actions or operations may be performed by a specially-programmed processor, a processor executing specially-programmed software or computer-readable media, or by any other combination of a hardware component and/or a software component capable of performing the described actions or functions.

FIG. 1 illustrates a wireless communication system 100 including a device 101 in communication coverage of a network entity 130 (e.g., a base station or node B (NodeB or NB) providing one or more cells). Device 101 can communicate with a network 160 via network entity 130 and/or a radio network control (RNC) 150. In an aspect, device 101 may have established one or more uplink channels over which uplink signals 173 can be transmitted for sending control and/or data transmissions (e.g., signaling) to network entity 130, and one or more downlink channels over which downlink signals 171 can be received for receiving control and/or data messages (e.g., signaling) via network entity 130 over configured communication resources. Device 101 may include a shared antenna 102 used for receiving downlink signals 171 and transmitting uplink signals 173. Thus, for example, a transmitted uplink signal 173 may be received by components of a receiver chain of the RF front end 104 when attempting to receive downlink signals 171 from the network entity 130.

In an aspect, device 101 may include one or more processors 103 and/or a memory 107 that may be communicatively coupled, e.g., via one or more buses 108, and may operate in conjunction with or otherwise implement a cancelation signal injector component 120 for providing analog interference cancelation for the shared antenna 102, which can be shared between transmit and receive resources (e.g., a transmitter chain and receiver chain of RF front end 104) of device 101, as described herein. For example, cancelation signal injector component 120 may execute various functions for determining one or more reference points in an RF front end 104 for generating a cancelation signal 119 and injecting the cancelation signal 119 into one or more injection points of the RF front end 104. The various functions related to cancelation signal injector component 120 may be implemented or otherwise executed by one or more processors 103 and, in an aspect, can be executed by a single processor, while in other aspects, different ones of the functions may be executed by a combination of two or more different processors. For example, in an aspect, the one or more processors 103 may include any one or any combination of a modem processor, or a baseband processor, or a digital signal processor, or an application specific integrated circuit (ASIC), or a transmit processor, or a transceiver processor associated with transceiver 106. Further, for example, the memory 107 may be a non-transitory computer-readable medium that includes, but is not limited to, random access memory (RAM), read only memory (ROM), programmable ROM (PROM), erasable PROM (EPROM), electrically erasable PROM (EEPROM), a magnetic storage device (e.g., hard disk, floppy disk, magnetic strip), an optical disk (e.g., compact disk (CD), digital versatile disk (DVD)), a smart card, a flash memory device (e.g., card, stick, key drive), a register, a removable disk, and any other suitable medium for storing software and/or computer-readable code or instructions that may be accessed and read by a computer or one or more processors 103. Moreover, memory 107 or computer-readable storage medium may be resident in the one or more processors 103, external to the one or more processors 103, or distributed across multiple entities including the one or more processors 103.

In particular, the one or more processors 103 and/or memory 107 may execute actions or operations defined by cancelation signal injector component 120 or its subcomponents. For instance, the one or more processors 103 and/or memory 107 may execute actions or operations defined by signal obtaining component 122 for obtaining signals from one or more reference points in the RF front end 104 (e.g., signals 115, 116, 117, 118 from one or more of reference points 110, 111, 112, 113, etc.). In an aspect, for example, signal obtaining component 122 may include hardware (e.g., one or more processor modules of the one or more processors 103) and/or computer-readable code or instructions stored in memory 107 and executable by at least one of the one or more processors 103 to perform the specially configured signal obtaining operations described herein. Further, for instance, the one or more processors 103 and/or memory 107 may execute actions or operations defined by reference/injection point selection component 124 for selecting one or more signals associated with one or more reference points (e.g., signals 115, 116, 117, 118 from one or more of reference points 110, 111, 112, 113, etc.) for generating the cancelation signal 119, and/or for selecting one or more injection points 114, 125 for injecting a resulting cancelation signal. In an aspect, for example, reference/injection point selection component 124 may include hardware (e.g., one or more processor modules of the one or more processors 103) and/or computer-readable code or instructions stored in memory 107 and executable by at least one of the one or more processors 103 to perform the specially configured reference point selection operations described herein. Further, for instance, the one or more processors 103 and/or memory 107 may execute actions or operations defined by cancelation signal generation component 126 for generating the cancelation signal 119 based on the selected reference point and injection point pair.

In one example, signal obtaining component 122 can obtain a plurality of signals from a plurality of reference points in RF front end 104 (e.g., at least in a transmitter chain of RF front end 104), which may include signals 115, 116, 117, 118 from one or more of reference points 110, 111, 112, 113. In this example, reference/injection point selection component 124 may select at least one of the reference points 110, 111, 112, 113 or related signals 115, 116, 117, 118 for generating a cancelation signal, and/or at least one of the injection points 114, 125 where the selection may be based on one or more of a given aggressor and victim set, expected analog interference cancelation metrics (e.g., a configured expected analog interference cancelation gain, a configured expected analog interference cancelation cost, etc., as described herein), one or more related thresholds that may be determined as part of a configuration received from network entity 130 or otherwise stored at device 101 (e.g., a threshold expected analog interference cancelation gain, a threshold expected analog interference cancelation cost, etc.).

In an example, the plurality of reference points may include substantially any reference point in a transmitter chain 131, such as a PA output, a filter component output (e.g., an individual filter, duplexer, filter bank, etc.), an input, stage, or output of a diplexer, etc. In the depicted example, the plurality of reference points may include: reference point 110 between the shared antenna 102 and diplexer 105; reference point 111 between the diplexer 105 and switch 142; reference point(s) 112 between the switch 142 and one or more filters 144 (e.g., which may be part of a duplexer or multiplexer in one example, and depending on the path selected by switch 142); and/or reference point(s) 113 between the filter(s) 144 and power amplifier(s) (PA) 145. It is to be appreciated that a diplexer 105 may include a multiple stage diplexer (e.g., combining a low and mid band at a first stage and then combined again with high band in a second stage. Thus, a reference point can be an output of one or more of the stages. A filter component (e.g., one or more filters 144) may include a duplexer, transmit filter (e.g., where there is a dedicated transmitter chain or time domain duplexing (TDD) chain), etc. Cancelation signal injector component 120 can inject one or more of the cancelation signals 119 into one or more injection points in the RF front end 104, such as injection point(s) 114, 125 between the low-noise amplifier(s) (LNA) 141 and filters 144 at an input of LNA 141, at an output of LNA 141, at one or more stages of the LNA, or other input to a filter 144, etc., for providing analog interference cancelation. Cancelation signal generation component 126 can generate cancelation signals, such as cancelation signal 119, for a combination of one or more of the selected reference points and/or one or more of the selected injection points or related signals obtained therefrom.

Moreover, in an aspect, device 101 may include RF front end 104 and transceiver 106 for receiving and transmitting radio transmissions. For example, transceiver 106 may communicate with the one or more processors 103 (or another processor) to obtain messages for transmitting via RF front end 104 and/or to provide messages received via RF front end 104 for processing. RF front end 104 may be connected to one or more shared antennas 102, which may include at least one shared antenna that is used to both transmit and receive signals. RF front end 104 may include a diplexer 105 for providing frequency division multiplexing (FDM) to multiplex multiple signals of multiple frequency bands. RF front end 104 can include one or more LNAs 141, one or more switches 142, one or more PAs 145, and one or more filters 144 for transmitting and receiving RF signals (e.g., uplink signals 173 and/or downlink signals 171). In an aspect, components of RF front end 104 can connect with transceiver 106 (e.g., LNAs 141, PAs 145, etc.). RF front end 104 can support communications over multiple bands via the multiple filters 144, LNAs 141, and/or PAs 145. Thus, for example, each filter 144 can relate to a certain frequency band within which the RF front end 104 can transmit or receive signals.

In an aspect, LNAs 141 can amplify a received signal at a desired output level. In an aspect, each LNA 141 may have a specified minimum and maximum gain values for amplifying the received signals. In an aspect, RF front end 104 may use one or more switches 142 to select a particular filter 144 path to an LNA 141. For example, the RF front end 104 may utilize a particular filter 144/LNA 141 based on the specified gain value of the LNA 141 and/or a desired gain value for a particular application.

Further, for example, one or more PA(s) 145 may be used by RF front end 104 to amplify a signal for an RF output transmission at a desired output power level. In an aspect, each PA 145 may similarly have a specified minimum and maximum gain values. In an aspect, RF front end 104 may use one or more switches 142 to select a particular filter 144 path and an associated PA 145 to achieve a desired gain value for a particular application based on the gain value of the PA 145.

Also, for example, one or more filters 144 can be used by RF front end 104 to filter a received signal to obtain an input RF signal. Similarly, in an aspect, for example, a respective filter 144 can be used to filter an output from a respective PA 145 to produce an output signal for transmission. In an aspect, each filter 144 can be connected to a specific LNA 141 and/or PA 145. In an aspect, RF front end 104 can use one or more switches 142 to select a transmit or receive path using a specified filter 144, LNA, 141, and/or PA 145, based on a configuration as specified by transceiver 106 and/or one or more processors 103.

Transceiver 106 may be configured to transmit and receive wireless signals through the shared antenna 102 via RF front end 104. In an aspect, transceiver 106 may be tuned to operate at specified frequencies such that device 101 can communicate with, for example, network entity 130 at a certain frequency. In an aspect, the one or more processors 103 may configure transceiver 106 to operate at a specified frequency and power level based on the device configuration of the device 101 and/or a communication protocol.

In an aspect, transceiver 106 can operate in multiple bands (e.g., using a multiband-multimode modem, not shown) such to process digital data sent and received using transceiver 106. In an aspect, transceiver 106 can be multiband and be configured to support multiple frequency bands for a specific communications protocol. In an aspect, transceiver 106 can be configured to support multiple operating networks and communications protocols. Thus, for example, transceiver 106 may enable transmission and/or reception of signals from the network based on a specified modem configuration. In an aspect, configuration of the transceiver 106 in this regard can be based on device configuration information associated with device 101 as provided by the network during cell selection and/or cell reselection.

In some aspects, device 101 may also be referred to by those skilled in the art (as well as interchangeably herein) as a user equipment (UE), mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. A device 101 may be a cellular phone, a personal digital assistant (PDA), a wireless modem, a wireless communication device, a handheld device, a tablet computer, a laptop computer, a cordless phone, a wireless local loop (WLL) station, a global positioning system (GPS) device, a multimedia device, a video device, a digital audio player (e.g., MP3 player), a camera, a game console, a wearable computing device (e.g., a smart-watch, smart-glasses, a health or fitness tracker, etc), an appliance, a sensor, a vehicle communication system, a medical device, a vending machine, or any other similar functioning device.

It is to be appreciated, in an aspect, other devices in the wireless communication system 100, such as network entity 130, can include and implement cancelation signal injector component 120. For instance, network entity 130 can be configured to perform analog interference cancelation at an RF front end for a shared antenna used to transmit and receive signals in the wireless network.

FIG. 2 illustrates a method 200 for selecting one or more of a plurality of cancelation signals generated from a plurality of reference points for injection into one or more injection points of an RF chain. Method 200 includes, at Block 202, obtaining a plurality of signals at a plurality of reference points in a transmitter chain of a shared antenna. In an aspect, for instance, signal obtaining component 122 can obtain the plurality of signals (e.g., signals 115, 116, 117, 118) at the plurality of reference points (e.g., reference points 110, 111, 112, 113) in a transmitter chain of the shared antenna 102. For example, the transmitter chain of shared antenna 102 can include a chain of coupled components such as, but not limited to, the diplexer 105, switch 142, one or more of the filters 144, one or more PAs 145, etc., which can be represented as chain 131 having diplexer 105, switch 142, filters 144, etc., which may operate as transmitter chain and receiver chain components, along with PA 145 shown in chain 132. The transmitter chain can also be referred to as the aggressor chain as it can be causing interference to the receiver chain. For example, the receiver chain of shared antenna 102 can include a chain of coupled components such as the diplexer 105, switch 142, one or more of the filters 144, one or more LNAs 141, etc., which can be represented as chain 131 having diplexer 105, switch 142, filters 144, etc., which may operate as transmitter chain and receiver chain components, along with LNA 141 shown in chain 133. The receiver chain can also be referred to as the victim chain as it can be interfered by signals from the transmitter chain.

As described, for example, the plurality of reference points may include at least a portion of reference points 110, 111, 112, and 113 depicted in RF front end 104. In this example, signal obtaining component 122 can tap signals from one or more of the reference points 110, 111, 112, and/or 113 in the RF front end 104, such as signals 115, 116, 117, and/or 118. For example, the one or more processors 103 may detect the signals 115, 116, 117, and/or 118 at each of one or more of the reference points 110, 111, 112, and/or 113 based at least in part on communicating with inputs/outputs to the related components (e.g., an output of PA(s) 145, an output of filter(s) 144, an output of switch 142, an output of diplexer 105, etc.).

Thus, in an example, obtaining the plurality of signals at Block 202 may optionally include, at Block 204, obtaining the plurality of signals specifically at an output of a PA, between a diplexer and duplexer, and/or between the diplexer and the shared antenna. In an aspect, for instance, signal obtaining component 122 may accordingly obtain the plurality of signals at output of the PA 145 (e.g., at reference point 113), between a diplexer 105 and duplexer, which may include filters 144 and/or switch 142 (e.g., at reference point 112 and/or 111), and/or between the diplexer 105 and the shared antenna 102 (e.g., at reference point 110).

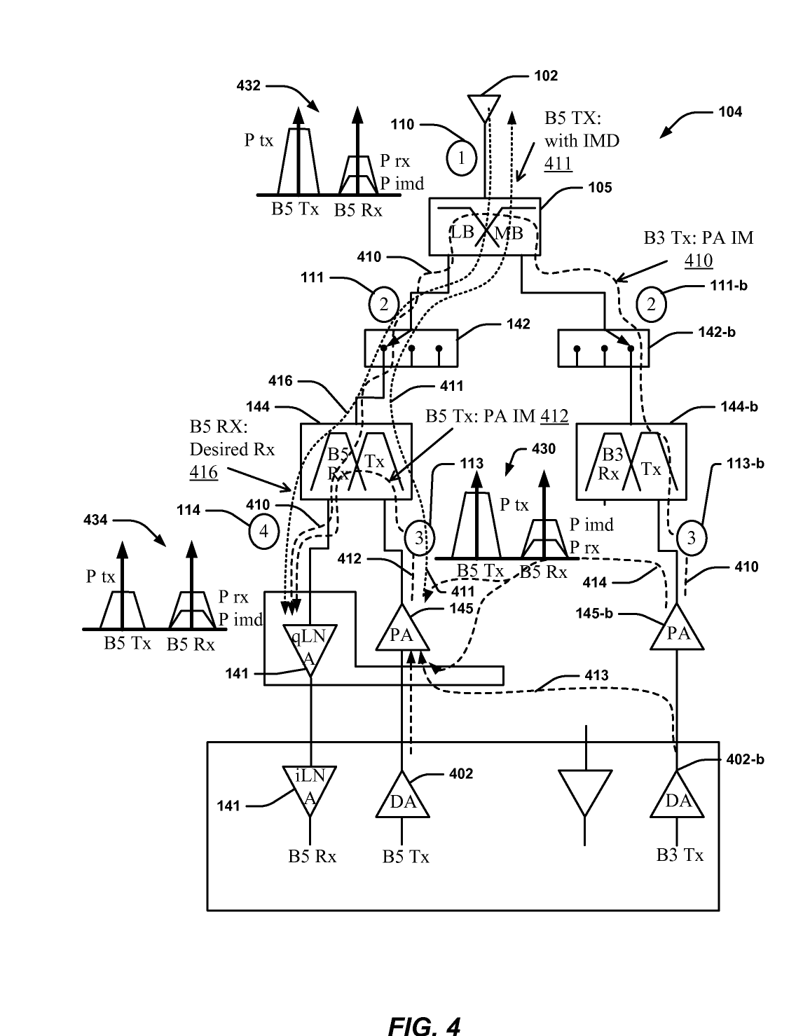

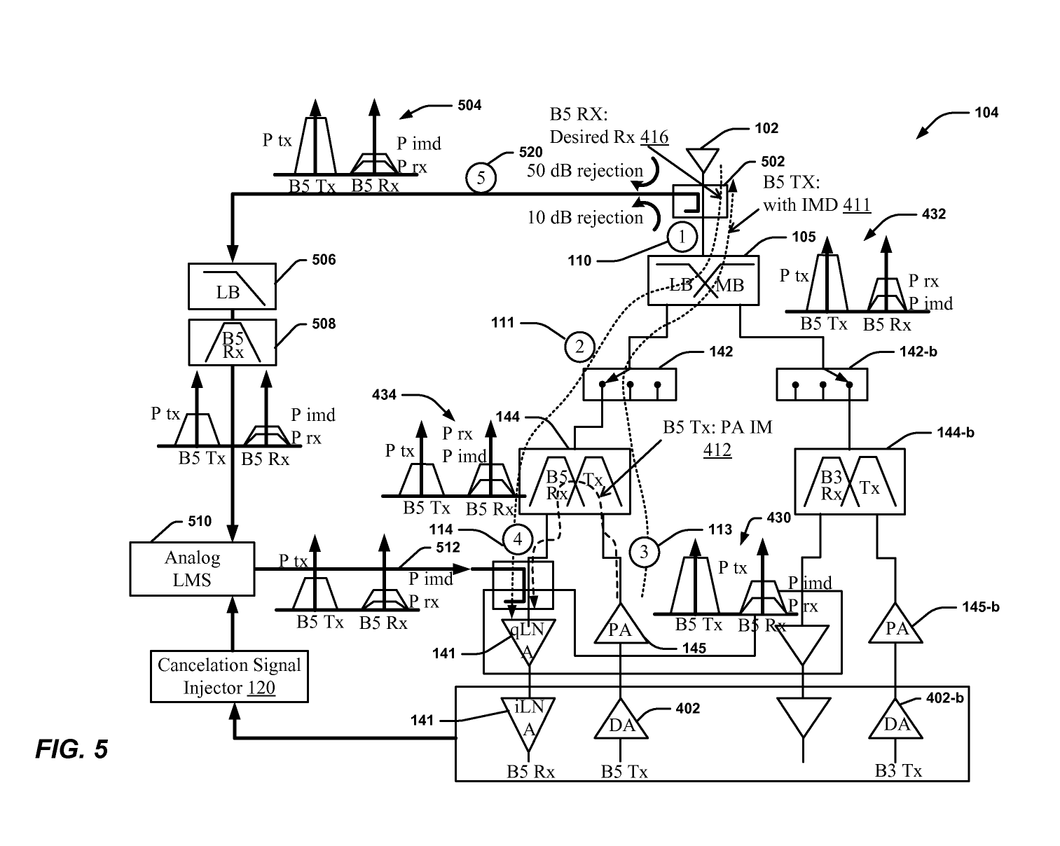

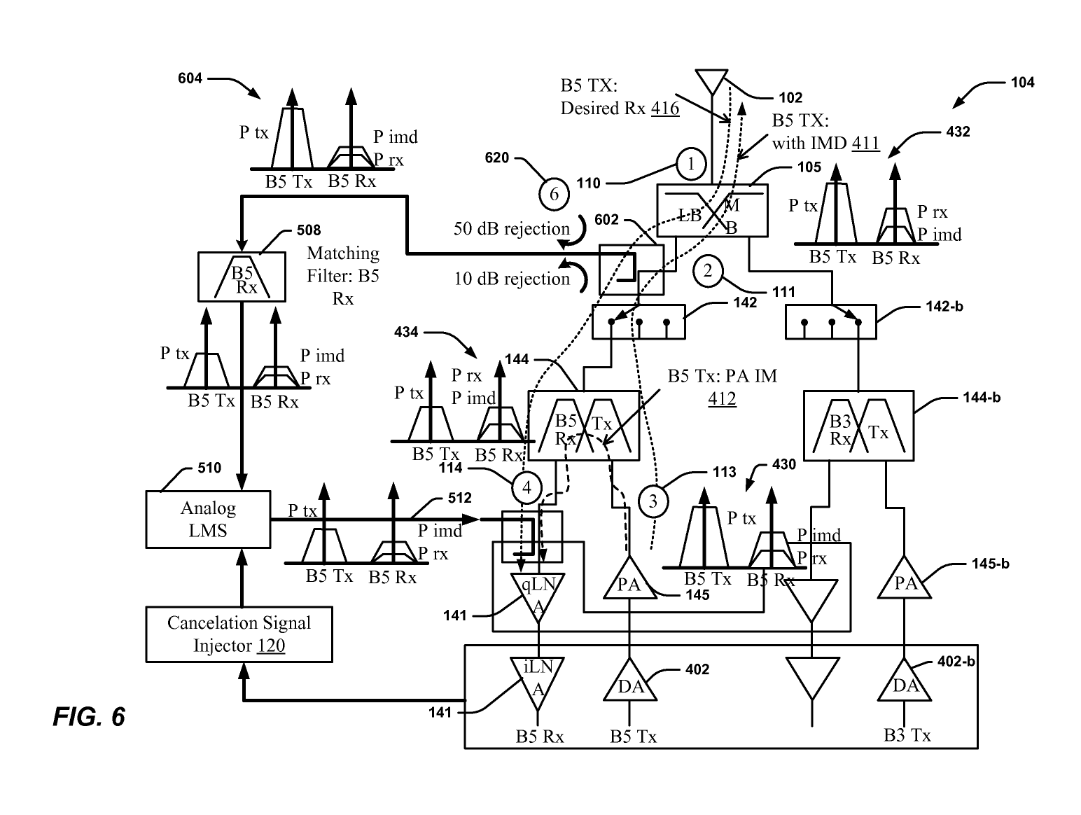

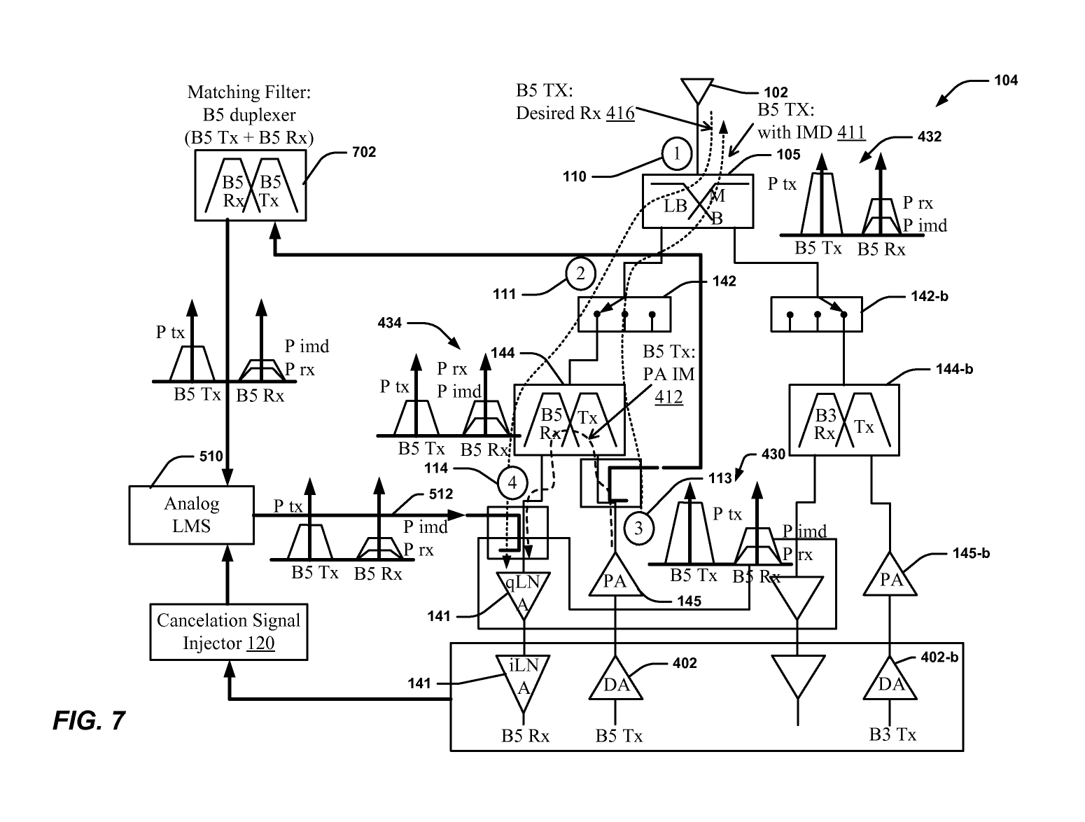

As described herein, the different reference points 110, 111, 112, and/or 113 can relate to different types of interference, and one or more of the reference points can be used to generate a cancelation signal to effectively cancel interference in the receiver chain based on one or more aspects of signals at the reference points. The one or more aspects of obtaining the signals can relate to determining which signal is suitable for canceling interference from signals received over the receiver chain (e.g., expected analog interference cancelation metrics, matching components, etc. of signals at the reference points, as is explained below in more detail). For example, FIG. 4 illustrates an example RF front end 104 explaining the different reference points 110, 111, 112, 113 for tapping the reference signal. FIG. 5 illustrates an example RF front end 104 where the reference signal for generating the cancelation signal is tapped from reference point 110. FIG. 6 illustrates an example RF front end 104 where the reference signal for generating the cancelation signal is tapped from reference point 111. FIG. 7 illustrates an example RF front end 104 where the reference signal for generating the cancelation signal is tapped from reference point 113.

Method 200 may also include, at Block 206, selecting at least one reference point of the plurality of reference points from which to generate a cancelation signal and/or at least one injection point for injecting the cancelation signal based at least in part on expected analog interference cancelation metrics related to each of the plurality of reference points and/or the at least one injection point. In an aspect, for instance, reference/injection point selection component 124 may select the at least one reference point of the plurality of reference points from which to generate a cancelation signal and/or at least one injection point for injecting the cancelation signal based at least in part on expected analog interference cancelation metrics related to each of the plurality of reference points and/or the at least one injection point. For example, selecting the at least one reference point and/or injection point pair may include reference/injection point selection component 124 selecting one or more of reference points 110, 111, 112, 113 and/or one or more of injection points 114, 125 based on one or more actions, as described in examples below.

For example, selecting the at least one reference point and/or at least one injection point at Block 206 may include reference/injection point selection component 124 selecting the injection point for the cancelation signal in the receiver chain. As described, for example, reference/injection point selection component 124 may select one or more injection points 114, 125 related to LNA 141 (e.g., an input to LNA 141, output of LNA 141, one or more stages of LNA 141 where LNA 141 is a multiple stage LNA, etc.) or other points in the receiver chain of the RF front end 104 to inject the cancelation signal, which may be based on determining an expected analog interference cancelation gain, as described further herein, a power consumption, LNA structure, etc. In another example, cancelation signal injector component 120 may be limited to one injection point, and no actual selection among multiple injection points may occur. In any case, expected analog interference cancelation metrics can be computed based on the plurality of reference points and/or injection points, as described herein.

In one example, selecting the at least one reference point and/or at least one injection point at Block 206 may optionally include, at Block 208, concurrently determining the expected analog interference cancelation metrics for each of the plurality of reference points and/or the at least one injection point. In an aspect, for instance, reference/injection point selection component 124 may concurrently determine the expected analog interference cancelation metrics for each of the plurality of reference points and/or the at least one injection point, which may include determining the metrics for each reference point and injection point pair. Thus, for example, reference/injection point selection component 124 may determine the expected analog interference cancelation metrics for one reference point and injection point pair in parallel with determining similar metrics for another pair to mitigate processing delay.

In an example, selecting the at least one reference point and/or at least one injection point at Block 206 may also optionally include, at Block 210, selecting the at least one reference point and/or injection point (e.g., a pair including the at least one reference point and injection point) determined to have a highest expected analog interference cancelation gain. In an aspect, for instance, reference/injection point selection component 124 can select the at least one signal from at least one of the reference points (e.g., at least one of signals 115, 116, 117, 118, etc.) determined to have the highest expected analog interference cancelation gain when injected into at least one of the injection points as cancelation signal 119 (e.g., into injection point 114, 125, etc.). This can include reference/injection point selection component 124 computing and comparing expected analog interference cancelation gain of the plurality of signals related to each of the plurality of reference points and/or the at least one injection point (e.g., the pairs of reference points and injection point(s)).

Thus, for example, the expected analog interference cancelation metrics can include expected analog interference cancelation gain, and reference/injection point selection component 124 can determine the expected analog interference cancelation gain for each of the plurality of pairs of reference points and injection point(s). For example, reference/injection point selection component 124 can determine matching components for matching a RF path mismatch, such as filter group delay (e.g., of filters 144), noise figure, gain, etc. between signals received at each of the reference points 110, 111, 112, 113, and/or a corresponding interference signal at injection point 114, 125, where the signals can traverse through the receiver chain from the corresponding reference point. If the matching components match the RF path mismatch, cancelation signal generation component 126 may generate a desirable cancelation signal based on the matching components (e.g., using the matching components or through the matching components) and provide a desirable cancelation gain. Any residual mismatches due to part by part variation or using different components may degrade cancelation signal quality and cancelation gain. Reference/injection point selection component 124 may determine the expected cancelation gain, which can be a function of the residual mismatches after matching components are matched for the RF path mismatch. The reference point 110, 111, 112, 113/injection point 114, 125 pair having the lowest residual RF path mismatch, noise figure difference, etc. after matching components may be selected as the reference point and injection point pair with the highest expected analog interference cancelation gain. In another example, the reference point/injection point pairs may be accordingly ranked in terms of highest expected analog interference cancelation gain for further consideration based on lowest expected analog interference cancelation cost or other parameters, as described herein.

In an example, selecting the at least one reference signal and/or injection signal at Block 206 may also optionally include, at Block 212, selecting the at least one reference signal and/or injection signal determined to have a lowest expected analog interference cancelation cost (e.g., while achieving a configured analog interference cancelation gain). In an aspect, for instance, reference/injection point selection component 124 can select the at least one pair (e.g., at least one of signals 115, 116, 117, 118, etc.) determined to have the lowest expected analog interference cancelation cost when injected into at least one of the injection points as cancelation signal 119 (e.g., into injection point 114, 125, etc.). This can include reference/injection point selection component 124 computing and comparing expected analog interference cancelation cost of each of the plurality of signals related to each of the plurality of reference points and/or the at least one injection point (e.g., the pairs of reference points and injection point(s)).

Thus, for example, the expected analog interference cancelation metrics can include expected analog interference cancelation cost, and reference/injection point selection component 124 can determine the expected analog interference cancelation cost for each of the plurality of pairs of reference points and injection point(s). For example, reference/injection point selection component 124 can determine at least one of matching components (e.g., matching filters, amplifiers, delay lines, etc.) and associated costs for cancelation signal generation to match RF path mismatches between signals received at the reference points and resulting cancelation signals injected at injection point, number of reference points, etc. for each of the pairs. The reference point 110, 111, 112, 113/injection point 114, 125 pair having the lowest matching component cost, reference point cost, etc., among the pairs (e.g., which also achieve a configured analog cancelation gain), may be selected as the reference point and injection point pair with lowest expected analog interference cancelation cost.

In one example, reference/injection point selection component 124 can select the reference point and/or injection point (e.g., which may include a pair of the reference point and injection point) based on a combination of the expected analog interference cancelation gain and expected analog interference cancelation cost. For example, reference/injection point selection component 124 can select the reference point 110, 111, 112, 113, and/or an injection point 114, 125 to achieve a threshold expected analog interference cancelation gain (which may be a value configured in the device, such as in a fixed or removable memory, hardcoding, etc. that may include memory 107), and if the gain is met, reference/injection point selection component 124 can select the reference point and/or the injection point based on a function of the cost and/or gain. For example, reference/injection point selection component 124 can then select the reference point and/or the injection point having a highest revenue function value which can be defined as combination of cost and gain among the pairs (e.g., which achieve the configured analog cancelation gain).

Method 200 may also include, at Block 214, generating the cancelation signal based at least in part on the at least one reference point and/or injection point. In an aspect, for instance, cancelation signal generation component 126 can generate the cancelation signal based at least in part on the at least one reference point and/or injection point. Generating the cancelation signal may include cancelation signal generation component 126 generating the cancelation signal from the signal at the reference point to have an inverted phase of the target interference signal (e.g., the signal at the injection point which can traverse through the receiver chain from reference point) for injecting at the injection point. In addition, for example, cancelation signal generation component 126 can generate the cancelation signal 119 as an analog signal also having the same or at least a similar amplitude as target interference signal (e.g., the interference signal at injection point 114, 125, etc., which can traverse through the receiver chain from reference point) for injecting at the injection point. For example, cancelation signal generation component 126 can generate the cancelation signal 119 based at least in part on obtaining a sample of the at least one signal (e.g., at least one of signals 115, 116, 117, 118) tapped from the one or more reference points (e.g., reference points 110, 111, 112, 113), reconstructing distortion to match RF path mismatches between the one or more reference points and/or injection points, inverting phase of the reconstructed signal, and injecting the signal to one or more injection points (e.g., the selected injection point) to cancel the target interference signal in injection point. In this regard, any out-of-band (OOB) and/or inter-modulation (IMD) interference that may be generated by the at least one transmitter chain may be included in the generated cancelation signal 119 for effectively canceling the OOB and/or IMD interference observed at at least one receiver chain (e.g., at one or more of the injection points 114, 125).

In this regard, method 200 can also include, at Block 218, injecting the cancelation signal in a receiver chain of the shared antenna to cancel interference from signals generated at the transmitter chain of the shared antenna. In an aspect, for instance, cancelation signal injector component 120 can inject the cancelation signal 119 in the receiver chain of the shared antenna to cancel interference from the signals generated at the transmitter chain. Thus, cancelation signal injector component 120 can inject the cancelation signal 119 in one or more injection points in the receiver chain, such as but not limited to an injection point 114 between LNA 141 and filters 144 at an input of LNA 141, an injection point 125 at an output of LNA 141, etc. It is to be appreciated that the injection point 114, 125 may also include one or more stages of the LNA 141, etc. For example, cancelation signal injector component 120 can feed the cancelation signal 119 into an input of LNA 141, add the cancelation signal 119 to another signal being fed to the input of the LNA 141 (e.g., a signal being received via shared antenna 102), etc. As described, in an example, reference/injection point selection component 124 can select the injection point for injecting the cancelation signal 119, as described with respect to Block 206 above.

FIG. 3 illustrates an example method 300 for selecting one or more of a plurality of reference points and/or injection points for generating and/or injecting a cancelation signal. In this example method 300, the cancelation signals can be selected based at least in part on determining whether the signals have matching components related to the reference point and injection point pairs.

Method 300 includes, at Block 202, obtaining a plurality of signals at a plurality of reference points in a transmitter chain of a shared antenna. In an aspect, for instance, signal obtaining component 122 can obtain the plurality of signals at the plurality of reference points in a transmitter chain of the shared antenna 102, as described above. Method 300 may also optionally include, at Block 302, determining a plurality of matching components for each of the plurality of reference points and/or the at least one injection point. In an aspect, for instance, reference/injection point selection component 124 can determine the plurality of matching components for each of the plurality of reference points and/or the at least one injection point (e.g., pairs of the reference points and injection point(s)). For example, each of the plurality of reference point/injection point pairs may have a number of matching components (e.g., matching filters) from other transmitter/receiver chains in the device which may be used to match the RF path mismatch between reference point and injection point.

Method 300 may also optionally include, at Block 304, determining a subset of the plurality of signals having certain corresponding matching components of the plurality of matching components, which may be shared between subset of the plurality of signals. In an aspect, for instance, reference/injection point selection component 124 can determine the subset of the plurality of signals (e.g., a subset of signals 115, 116, 117, 118) having certain corresponding matching components of the plurality of matching components, which may be shared between the subset of the plurality of signals. For example, reference/injection point selection component 124 can determine the subset of the plurality of signals having similar signal characteristics, as being of the same or different band group as the signal received at the receiver chain of the RF front end 104, including similar components in a transmitter and/or receiver chain, etc.

Method 300 may also optionally include, at Block 306, selecting at least one reference point of the subset of reference points and/or at least one injection point from which to generate a cancelation signal based at least in part on expected analog interference cancelation metrics related to each of the subset of reference points and/or the at least one injection point. In an aspect, for instance, reference/injection point selection component 124 may select the at least one reference point of the subset of reference points and/or at least one injection point from which to generate a cancelation signal 119 based at least in part on the expected analog interference cancelation metrics related to each of the subset of reference points and/or the at least one injection point.

In one example, selecting the at least one reference point and/or injection point at Block 306 may optionally include, at Block 310, selecting the at least one reference point and/or injection point determined to have a highest expected analog interference cancelation gain. In an aspect, for instance, reference/injection point selection component 124 can select the at least one reference point and/or injection point (e.g., a pair of a reference point and injection point) determined to have the highest expected analog interference cancelation gain, as described. In another example, selecting the at least one signal at Block 306 may also optionally include, at Block 312, selecting the at least one reference point and/or injection point determined to have a lowest expected analog interference cancelation cost. In an aspect, for instance, reference/injection point selection component 124 can select the at least one reference point and/or injection point (e.g., a pair of a reference point and injection point) determined to have the lowest expected analog interference cancelation cost, as described. In addition, as described, reference/injection point selection component 124 can select the at least one reference point and/or injection point as a function of expected analog interference cancelation gain and expected analog interference cancelation cost, etc. as described.

Method 300 may also include, at Block 214, generating the cancelation signal based at least in part on the at least one reference point and/or injection point. In an aspect, for instance, cancelation signal generation component 126 can generate the cancelation signal 119 based at least in part on the at least one reference point and/or injection point (e.g., at least one of reference points 110, 111, 112, 113, injection points 114, 125, etc.), as described. Method 300 can also include, at Block 218, injecting the cancelation signal in a receiver chain of the shared antenna to cancel interference from signals generated at the transmitter chain of the shared antenna. In an aspect, for instance, cancelation signal injector component 120 can inject the cancelation signal 119 in the receiver chain of the shared antenna (e.g., into an input of LNA 141) to cancel interference from the signals generated at the transmitter chain, as described.

FIGS. 4-7 illustrate example shared antenna 102 and RF front end 104 with possible interference between a transmitter chain and receiver chain, as described above. FIGS. 4-7 provide explanation as to selecting signals from one or more reference points 110, 111, 113 for generating cancelation signal 119, as described above with respect to Block 206 (FIG. 2) and/or Block 306 (FIG. 3). Though generally described in terms of interference related to band 5 (B5) and band 3 (B3) communications in LTE, it is to be appreciated that similar concepts and functions described herein can be applied to substantially any frequency bands utilized in communicating by RF front end 104 and shared antenna 102.

Referring to FIG. 4, an RF front end 104 is depicted including multiple possible reference points 1 110, 2 111, and 3 113, for tapping a reference signal to generate a cancelation signal for injecting into a receiver chain of the RF front end 104. RF front end 104 can include a diplexer 105, switches 142, 142-b, filters 144, 144-b, LNAs 141 (e.g., q-component LNA (qLNA) and i-component LNA (iLNA)), PAs 145, 145-b, distributed amplifiers (DA) 402, 402-b, etc. Diplexer 105 can diplex communications from switches 142, 142-b and a low band (LB) or midband (MB). In the depicted example, the components of a first transmitter chain, which can include switch 142, filter 144, PA 145, and DA 402, can relate to a B5 in LTE transmitting at a frequency band of around 824-849 megahertz (MHz). Components of a second transmitter chain, which can include switch 142-b, filter 144-b, PA 145-b, and DA 402-b, can relate to a B3 in LTE transmitting at a frequency band of around 1710-1785 MHz. In addition, components of the receiver chain, which can include switch 142, filter 144, and LNAs 141, cam relate to BR receiving at a frequency band of around 869-894 MHz. Filter 144 can be used to filter B5 transmissions from the first transmitter chain and B5 receptions from the receiver chain. Filter 144-b can be used to filter B3 transmissions from the second transmitter chain and B3 receptions from another receiver chain (if present, though not shown).

In the depicted example, B3 transmissions on the second transmitter chain (an aggressor RF path) can produce various signals that may interfere with B5 receptions on the receiver chain (a victim RF path). For example, PA 145-b can generate signal 410 for transmission via the shared antenna 102, which can traverse the components of the second transmitter chain, and can interfere with signal 416 received at the shared antenna 102, where the interference can occur in the diplexer 105 (e.g., as the B3 transmission and B5 reception are on different bands). In addition, B5 transmissions on the first transmitter chain (another aggressor RF path) can produce signal 411 for transmission via shared antenna 102. As part of generating signals 411, PA 145 can generate signals 412 that can cause inter-modulation (IMD) interfere with signal 416 received at the shared antenna 102. This can be the dominant interference based on the lower pathloss of the signals 412 as compared to signals 410. Signals 412 can interfere with signal 416 at the filter 144 (e.g., duplexer) that filters B5 receptions and transmissions. In addition, for example, signals 413 from the DA 402-b can be received at the PA 145 and can cause additional interference in signals 412. Similarly, for example, signals 414 from PA 145-b can cause additive noise that adds interference to signals 412. These various sources of interference to signal 416 being received on the receiver chain can be canceled using analog interference cancelation based on one or more reference points, as described herein.

For example, at reference point 3 113 after the PA 145, the strongest IMD signal 412, which can be generated from signal 411, is observed. As shown at 430, this signal 412 has a higher IMD power (Pimd) than the receive power (Prx) of signal 416, and also signal 411 has a higher transmit power (Ptx) than the Prx. At reference point 2 111 between the diplexer 105 and switch 142, and reference point 4 114 between the filter 144 and LNA 141, the IMD signal 412 may have lower power, group delay, and distortion due to B5 transmit filter rejection in the filter 144 portion of the duplexer. At reference point 2 111 and reference point 4 114, as shown at 432 and 434 respectively, Prx is higher than Pimd. This can be due to the B5 tx filter 144-b providing additional rejection on Prx, which makes the cancelation signal quality better than other cases (e.g., power ratio of Pimd over Prx is higher). At reference point 4 114, however as shown at 434, Ptx is the same or similar as Prx due to filtering of the B5 transmit and receive signals by filter 144.

Additional possible reference points include reference point 111-b between diplexer 105 and switch 142-b, and reference point 113-b after PA 145-b, which relate to the B3 transmission signal 410. Selection of one or more of the reference points based on which to generate a cancelation signal can include selecting a reference point with enough signal power level differentiation between the victim receive signal 412 and the aggressor interference signal (e.g., signal 410, 411, 412, 413, 414, etc.), selecting a reference point having a group delay matching between the reference point and an injection point (e.g., injection point 4 114), and/or the like.

Selecting reference point 1 110 between the shared antenna 102 and diplexer 105 for generating a cancelation signal can cover the possible bands of aggressor signals (e.g., B3 and B5), and can thus be used to cancel interference from a combined aggressor signal (e.g., B3 and B5 transmitter signals 410 and 411); however, matching may be needed at the diplexer 105 (e.g., via additional band pass filters, not shown) for matching components between the signal at the diplexer 105 and the desired receive signal 416 to provide effective analog interference cancelation via a cancelation signal generated based on reference point 1 110. An example of an RF front end 104 for selecting reference point 1 110 for generating the cancelation signal 119 is shown in FIG. 5.

FIG. 5 illustrates the RF front end 104 with a directional coupler 502 between the shared antenna 102 and diplexer 105 to provide separation between the desired receiver signal 416 and the IMD signal 412 such to prevent cancelation of the receiver signal 416 when performing cancelation based on the signal at the reference point 1 110. For example, the directional coupler 502 can lower Prx and Pimd from 432, as shown at 504, to provide separation between the B5 transmitter signal 411 and the B5 receiver signal 416. In addition, a LB matching filter 506 and a B5 receiver matching filter 508 are provided. For example, LB matching filter 506 can reject any other transmitter band signals (e.g., signal 410 in FIG. 4), and the B5 receiver matching filter 508 can provide group delay compensation for the combined signal 411 and 416, and reject the transmitter signal 411 in the same band (B5 in this example) as the receiver signal 416. The resulting filtered signal can be provided to an analog least-mean-squared (LMS) filter 510 for injecting into LNA 141. Additionally, analog LMS filter 510 may receive input from cancelation signal injector component 120 (e.g., to indicate selection of reference point 1 110). In this example, the dominant interference path of the IMS signal 412 is from reference point 3 113 to reference point 2 111 to injection point 4 114. The path of the combined signal to the injection into LNA 141 is from reference point 3 113 to reference point 2 111 to reference point 1 110 into the directional coupler 504 to reference point 5 520 through filters 506, 508, and 510 to injection point 4 114.

In this example, the quality of the aggressor signal (e.g., B5 transmitter signal 411) may be degraded at reference point 1 110 due to the B5 duplexer (e.g., switch 142 and/or filter 144). In addition, filter mismatch (e.g., between the B5 duplexer (e.g., switch 142 and/or filter 144), B5 receiver filter 508, diplexer 105 and/or LB filter 506) may be higher than at other reference points as diplexer 105 is additionally matched through adding LB filter 506. Filters 506 and 508 are matching filters (matching components) to match diplexer 105 and the Rx filter portion of the B5 duplexer 144. Filter 510 can provide additional adaptation to minimize the residual mismatches, such as phase rotation, gain difference, etc., and/or to provide the phase-inverted cancelation signal, as described. Signal 512 from filter 510 can include a cancelation signal with a similar (e.g., the same) amount power of Pimd as Pimd at reference point 4 114 (Pimd shown at 434) but phase-inverted. Thus, Pimd shown at 434 can be canceled by the cancelation signal 512 from filter 510. Cancelation signal 512 from filter 510 may include a desired signal power, Prx, which may degrade the quality of Prx as shown at 434, but the amount of Prx from the cancelation signal 512 can be small enough to minimize impact on Prx shown at 434. In addition, for example, directional coupler 502 can provide higher rejection for Prx than the amount of rejection for Pimd, which makes Pimd higher in the signal output from the directional coupler 502.

Referring back to FIG. 4, selecting reference point 2 111 (or 111-b) between the diplexer 105 and switch 142 (or 142-b) for generating a cancelation signal can cover a band group (e.g., associated with the first transmitter chain or the second transmitter chain) of aggressor signals. Thus, signals from this reference point can be used to cancel interference from an aggressor signal (without diplexer matching) if the aggressor signal is in the same band as the receiver signal (e.g., such as signals 411 and 416). If the aggressor signal is in a different band (e.g., signal 410), however, a signal from reference point 2 111 (or 111-b) may not reflect sufficient aggressor signal quality (e.g., without additional band pass filters at the diplexer 105), and thus may not facilitate producing a representative cancelation signal to effectively cancel interference from the receiver signal 416. An example of an RF front end 104 for selecting reference point 2 111 for generating the cancelation signal 119 is shown in FIG. 6.

FIG. 6 illustrates the RF front end 104 with a directional coupler 602 between the diplexer 105 and duplexer (e.g., switch 142) to provide separation between the desired receiver signal 416 and the IMD signal 412 such to prevent cancelation of the receiver signal 416 when performing cancelation based on the signal at the reference point 2 111. For example, the directional coupler 602 can lower Prx and Pimd from 432, as shown at 604, to provide separation between the B5 transmitter signal 411 and the B5 receiver signal 416. In addition, a B5 receiver matching filter 508 can provide group delay compensation for the combined signal 411 and 416, and reject the transmitter signal 411 in the same band (B5 in this example) as the receiver signal 416. The resulting filtered signal can be provided to an analog LMS filter 510 for injecting into LNA 141. Additionally, analog LMS filter 510 may receive input from cancelation signal injector component 120 (e.g., to indicate selection of reference point 2 111). In this example, the dominant interference path of the IMS signal 412 is from reference point 3 113 to reference point 2 111 to injection point 4 114. The path of the combined signal to the injection into LNA 141 is from reference point 3 113 to reference point 2 111 into the directional coupler 604 to reference point 6 620 through filters 508 and 510 to injection point 4 114. In this example, the quality of the aggressor signal (e.g., B5 transmitter signal 411) may be improved as compared to reference point 1 110 where the aggressor signal is in the same band as the receiver signal 416. In addition, reference point 2 111 may be used to generate cancelation signals applying to a band group related to signal 411.

Referring back to FIG. 4, selecting reference point 3 113 (or 113-b) after the PA 145 (or 145-b) for generating a cancelation signal can provide separation between an aggressor signal and receiver signal in the same band group (e.g., B5 transmitter signal 411 and B5 receiver signal 416), and can thus be used to cancel interference from an aggressor signal in the same band as the receiver signal. Reference point 3 113 (or 113-b), however, may only cover output from PA 145 (or PA 145-b) (e.g., without additional band pass filters at the diplexer 105), and may not reflect transmit path distortion after the PA 145 (or PA 145-b). Thus, cancelation performance using this reference point 113 (or 113-b) may depend on the accuracy of path distortion modeling. An example of an RF front end 104 for selecting reference point 3 113 for generating the cancelation signal 119 is shown in FIG. 7.

FIG. 7 illustrates the RF front end 104 where reference point 3 113 is selected, and the corresponding signal can be provided to a matching filter (e.g., a duplexer) 702 for separating the aggressor transmitter signal 411 from the receiver signal 416. The resulting filtered signal is provided to an analog LMS filter 510 for injecting into LNA 141. Additionally, analog LMS filter 510 may receive input from cancelation signal injector component 120 (e.g., to indicate selection of reference point 3 113). In this example, the dominant interference path of the IMS signal 412 is from reference point 3 113 to reference point 2 111 to injection point 4 114. The path of the combined signal to the injection into LNA 141 is from reference point 3 113 through filters 702 and 510 to injection point 4 114. In this example, the quality of the aggressor signal (e.g., B5 transmitter signal 411) may be improved as compared to reference point 1 110 and reference point 2 111 where the aggressor signal is in the same band as the receiver signal 416 as the output of the PA 145 (or 145-b) can provide improved separation between the aggressor signal (e.g., B5 transmitter signal 411) and the receiver signal 416; however, multiple reference points may be needed per PA 145 (or 145-b) to cancel signals from other bands. Filter 702 can be a matching filter (matching component) to match the B5 duplexer 144.

As described, each of the reference points 110, 111, 112, and/or 113 may have different benefits in different scenarios based on the source of the aggressor interfering transmitter signal. Accordingly, as described with respect to FIGS. 1-3, reference/injection point selection component 124 can determine which reference point(s) 110, 111, 112, and/or 113 (e.g., and/or injection points 114, 125) to utilize in generating a cancelation signal based on determining an expected analog interference cancelation cost or gain for each of the reference points, and selecting the reference point(s) with the highest expected analog interference cancelation gain or the lowest expected analog interference cancelation cost. In addition, in an example, reference/injection point selection component 124 can determine matching components for signals at each of the reference point(s) 110, 111, 112, and/or 113 (e.g., and/or based on injection points 114, 125), and may determine a subset of the reference point(s) 110, 111, 112, and/or 113 for which corresponding signals meet a threshold number of matching components. Reference/injection point selection component 124 can accordingly select one or more reference points 110, 111, 112, and/or 113 (and/or injection points 114, 125) for generating the cancelation signal based at least in part on determining the reference point(s) in the subset that have a highest expected analog interference cancelation gain or the lowest expected analog interference cancelation cost.

Several aspects of a telecommunications system have been presented with reference to a W-CDMA system. As those skilled in the art will readily appreciate, various aspects described herein may be extended to other telecommunication systems, network architectures and communication standards.

By way of example, various aspects described herein may be extended to other UMTS systems such as W-CDMA, TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects described herein, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described herein. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the functionality described herein depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods or methodologies described herein may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

What is claimed is:

1. A method for providing analog interference cancelation in a shared antenna, comprising:
obtaining a plurality of signals at a plurality of reference points in a transmitter chain of a shared antenna;
selecting at least one reference point of the plurality of reference points from which to generate a cancelation signal and/or at least one injection point for injecting the cancelation signal based at least in part on expected analog interference cancelation metrics related to each of the plurality of reference points and/or the at least one injection point;
generating the cancelation signal based at least in part on the at least one reference point and/or the at least one injection point; and
injecting the cancelation signal in the at least one injection point at a receiver chain of the shared antenna to cancel interference from signals generated at the transmitter chain of the shared antenna.

2. The method of claim 1, wherein the plurality of reference points correspond to at least one of a first reference point from an output of a power amplifier in the transmitter chain, a second reference point from an output of a filter component in the transmitter chain, a third reference point at an input, output, or one or more stages of a diplexer in the transmitter chain.

3. The method of claim 1, wherein the at least one injection point includes a low-noise amplifier (LNA) in the receiver chain, or an input to a filter component.

4. The method of claim 3, wherein the at least one injection point includes at least one of an input of the LNA, an output of the LNA, one or more stages of the LNA.

5. The method of claim 1, wherein the expected analog interference cancelation metrics correspond to an expected analog interference cancelation gain for each of the plurality of reference points and/or the at least one injection point, and wherein selecting the at least one reference point and/or the at least one injection point comprises comparing expected analog interference cancelation gain for each of a plurality of pairs of the plurality of reference points and the at least one injection point to determine the at least one of the plurality of pairs as having a highest expected analog interference cancelation gain.

6. The method of claim 5, further comprising determining a plurality of matching components related to each of the plurality of pairs, wherein selecting the at least one reference point and/or the at least one injection point comprises:
determining a subset of the plurality of reference points related to the plurality of signals having certain corresponding matching components of the plurality of pairs; and
selecting the at least one reference point and/or the at least one injection point from the subset of the plurality of pairs having the highest expected analog interference cancelation gain.

7. The method of claim 1, wherein the expected analog interference cancelation metrics correspond to an expected analog interference cancelation cost for each of the plurality of reference points and/or the at least one injection point, and wherein selecting the at least one reference point and/or the at least one injection point comprises comparing expected analog interference cancelation cost for each of a plurality of pairs of the plurality of reference points and the at least one injection point to determine the at least one of the plurality of pairs as having a lowest expected analog interference cancelation cost.

8. The method of claim 7, further comprising determining a plurality of matching components for each of the plurality of pairs, wherein selecting the at least one reference point and/or the at least one injection point comprises:
determining a subset of the plurality of reference points related to the plurality of signals having certain corresponding matching components of the plurality of pairs; and
selecting the at least one reference point and/or the at least one injection point from the subset of the plurality of pairs having the lowest expected analog interference cancelation cost.

9. The method of claim 1, further comprising concurrently determining the expected analog interference cancelation metrics for each of the plurality of reference points and/or the at least one injection point.

10. The method of claim 1, further comprising selecting the at least one injection point in the receiver chain for the cancelation signal in the receiver chain.

11. An apparatus for providing analog interference cancelation in a shared antenna, comprising:
an antenna shared between a transmitter chain and a receiver chain;
at least one processor communicatively coupled with the transmitter chain and the receiver chain via a bus;
a memory communicatively coupled with the transmitter chain, the receiver chain, and the at least one processor via the bus; and
wherein the at least one processor and the memory are operable to:
obtain a plurality of signals at a plurality of reference points in the transmitter chain of a shared antenna;
select at least one reference point of the plurality of reference points from which to generate a cancelation signal and/or at least one injection point for injecting the cancelation signal based at least in part on expected analog interference cancelation metrics related to each of the plurality of reference points and/or the at least one injection point;
generate the cancelation signal based at least in part on the at least one reference point and/or the at least one injection point; and
inject the cancelation signal in the at least one injection point at the receiver chain of the shared antenna to cancel interference from signals generated at the transmitter chain of the shared antenna.

12. The apparatus of claim 11, wherein the transmitter chain comprises:
a diplexer;
a filter component; and
a power amplifier,
wherein the plurality of reference points correspond to at least one of a first reference point from an output of the power amplifier, a second reference point from an output of the filter component, a third reference point at an input, output, or one or more stages of the diplexer.

13. The apparatus of claim 11, wherein the at least one injection point includes a low-noise amplifier (LNA), or an input to a filter component.

14. The apparatus of claim 13, wherein the at least one injection point includes at least one of an input of the LNA, an output of the LNA, or one or more stages of the LNA.

15. The apparatus of claim 11, wherein the expected analog interference cancelation metrics correspond to an expected analog interference cancelation gain for each of the plurality of reference points and/or the at least one injection point, and wherein the at least one processor and the memory are further operable to select the at least one reference point and/or the at least one injection point by comparing expected analog interference cancelation gain for each of a plurality of pairs of the plurality of reference points and the at least one injection point to determine the at least one of the plurality of pairs as having a highest expected analog interference cancelation gain.

16. The apparatus of claim 15, wherein the at least one processor and the memory are further operable to determine a plurality of matching components related to each of the plurality of pairs and to select the at least one reference point and/or the at least one injection point by:
determining a subset of the plurality of reference points related to the plurality of signals having certain corresponding matching components of the plurality of pairs; and
selecting the at least one reference point and/or the at least one injection point from the subset of the plurality of pairs having the highest expected analog interference cancelation gain.

17. The apparatus of claim 11, wherein the expected analog interference cancelation metrics correspond to an expected analog interference cancelation cost for each of the plurality of reference points and/or the at least one injection point, and wherein the at least one processor and the memory are further operable to select the at least one reference point and/or the at least one injection point by comparing expected analog interference cancelation cost for each of a plurality of pairs of the plurality of reference points and/or the at least one injection point to determine the at least one of the plurality of pairs as having a lowest expected analog interference cancelation cost.

18. The apparatus of claim 17, wherein the at least one processor and the memory are further operable to determine a plurality of matching components for each of the plurality of pairs and to select the at least one reference point and/or the at least one injection point by:
determining a subset of the plurality of reference points related to the plurality of signals having certain corresponding matching components of the plurality of pairs; and
selecting the at least one reference point and/or the at least one injection point from the subset of the plurality of pairs having the lowest expected analog interference cancelation cost.

19. The apparatus of claim 11, wherein the at least one processor and the memory are further operable to concurrently determine the expected analog interference cancelation metrics for each of the plurality of reference points and/or the at least one injection point.

20. The apparatus of claim 11, wherein the at least one processor and the memory are further operable to select the at least one injection point in the receiver chain for the cancelation signal in the receiver chain.

21. An apparatus for providing analog interference cancelation in a shared antenna, comprising:
means for obtaining a plurality of signals at a plurality of reference points in a transmitter chain of a shared antenna;
means for selecting at least one reference point of the plurality of reference points from which to generate a cancelation signal and/or at least one injection point for injecting the cancelation signal based at least in part on expected analog interference cancelation metrics related to each of the plurality of reference points and/or the at least one injection point;
means for generating the cancelation signal based at least in part on the at least one reference point and/or the at least one injection point; and
means for injecting the cancelation signal in the at least one injection point at a receiver chain of the shared antenna to cancel interference from signals generated at the transmitter chain of the shared antenna.

22. The apparatus of claim 21, wherein the plurality of reference points correspond to at least one of a first reference point from an output of a power amplifier in the transmitter chain, a second reference point from an output of a filter component in the transmitter chain, a third reference point at an input, output, or one or more stages of a diplexer in the transmitter chain.

23. The apparatus of claim 21, wherein the at least one injection point includes a low-noise amplifier (LNA) in the receiver chain, or an input to a filter component.

24. The apparatus of claim 21, wherein the expected analog interference cancelation metrics correspond to an expected analog interference cancelation gain for each of the plurality of reference points and/or the at least one injection point, and wherein means for selecting selects the at least one reference point and/or the at least one injection point by comparing expected analog interference cancelation gain for each of a plurality of pairs of the plurality of reference points and/or the at least one injection point to determine the at least one of the plurality of pairs as having a highest expected analog interference cancelation gain.

25. The apparatus of claim 21, wherein the expected analog interference cancelation metrics correspond to an expected analog interference cancelation cost for each of the plurality of reference points and/or the at least one injection point, and wherein means for selecting selects the at least one reference point and/or the at least one injection point by comparing expected analog interference cancelation cost for each of a plurality of pairs of the plurality of reference points and/or the at least one injection point to determine the at least one of the plurality of pairs as having a lowest expected analog interference cancelation cost.

26. A computer-readable medium storing code executable by a computer for providing analog interference cancelation in a shared antenna, the code comprising:
code for obtaining a plurality of signals at a plurality of reference points in a transmitter chain of a shared antenna;
code for selecting at least one reference point of the plurality of reference points from which to generate a cancelation signal and/or at least one injection point for injecting the cancelation signal based at least in part on expected analog interference cancelation metrics related to each of the plurality of reference points and/or the at least one injection point;
code for generating the cancelation signal based at least in part on the at least one reference point and/or the at least one injection point; and
code for injecting the cancelation signal in the at least one injection point at a receiver chain of the shared antenna to cancel interference from signals generated at the transmitter chain of the shared antenna.

27. The computer-readable medium of claim 26, wherein the plurality of reference points correspond to at least one of a first reference point from an output of a power amplifier in the transmitter chain, a second reference point from an output of a filter component in the transmitter chain, a third reference point at an input, output, or one or more stages of a diplexer in the transmitter chain.

28. The computer-readable medium of claim 26, wherein the at least one injection point includes a low-noise amplifier (LNA) in the receiver chain, or an input to a filter component.

29. The computer-readable medium of claim 26, wherein the expected analog interference cancelation metrics correspond to an expected analog interference cancelation gain for each of the plurality of reference points and/or the at least one injection point, and wherein code for selecting selects the at least one reference point and/or the at least one injection point by comparing expected analog interference cancelation gain for each of a plurality of pairs of the plurality of reference points and/or the at least one injection point to determine the at least one of the plurality of pairs as having a highest expected analog interference cancelation gain.

30. The computer-readable medium of claim 26, wherein the expected analog interference cancelation metrics correspond to an expected analog interference cancelation cost for each of the plurality of reference points and/or the at least one injection point, and wherein code for selecting selects the at least one reference point and/or the at least one injection point by comparing expected analog interference cancelation cost for each of a plurality of pairs of the plurality of reference points and/or the at least one injection point to determine the at least one of the plurality of pairs as having a lowest expected analog interference cancelation cost.
